(19) United States
(12) Patent Application Publication
(10) Pub. No.: US 2010/0177143 A1
(43) Pub. Date: Jul. 15, 2010

(54) METHOD FOR PRINTING ENDLESS PRINTING SUBSTRATES DIGITALLY

(75) Inventor: Erwin Heimgartner, Ennetbaden (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: WP DIGITAL AG, Wittenbach (CH)

(21) Appl. No.: 12/602,833

(22) PCT Filed: May 23, 2008
(86) PCT No.: PCT/CH2008/000235

§ 371 Date: Dec. 3, 2009

(30) Foreign Application Priority Data
Jun. 15, 2007 (CH) 970/07

(51) Int. Cl. B41J 29/38

(52) U.S. Cl. 347/37

(57) ABSTRACT

A method for printing endless printing substrates digitally on an inkjet printing press (1), in which first a predefined region of the printing substrate (17) is under-printed with a base tint (for example, white ink) by the print head (9) being moved to and fro in the X-direction and movement of the bridge (7) in the Y-direction. After the region which has been provided with the base tint has been advanced in the Y-direction, overprinting is carried out there, wherein once again the print head (9) is moved to and fro in the X-direction, but the printing substrate (17) is moved in the Y-direction with the bridge (7) at a standstill. In one variant, the printing substrate is moved in the Y-direction with the bridge (7) at a standstill during the under-printing and the bridge (7) is moved in the Y-direction during the overprinting. The under-printing and overprinting can take place once or multiple times.

### BACKGROUND

The object of the invention is a method for digitally printing endless printing substrates.

It is known to apply even very large-area images, writings, etc. onto endlessly fed printing substrates in a digital printing method. Frequently, here the printing substrate is not white but colored so that prior to the color printing first a white printing must be prepared, in the following called under-printing. The application of the white dots all over or, for example for marking vehicle tarps, only in the area of said writing presently occurs usually in one of the following methods:
a) in two processing steps, by first executing the complete application of the white printing, followed by a return of the printing substrate to the initial position, and the subsequent application of the color printing,
b) in one processing step, by arranging the printing nozzles inside the print head such that the nozzles for the white printing are positioned, in the feeding direction, in front of the nozzles for the color printing, in the following called overprinting.

In the method a) the precision of the overprinting is not ensured in all cases, while in the method b) the printing settings of color and white printing are coupled, i.e. only certain combinations, e.g. resolutions, are possible.

### SUMMARY

The object of the present invention is to provide a method allowing a precise multiple printing with printing dots positioned over top of each other and with high efficiency.

This object is attained in a method according to the invention. Advantageous embodiments of the method are described in the dependent claims.

The complete separation of the application of the under-printing and/or white printing from the overprinting, i.e. the color or additional white printing, allow the execution of both types of printing at a high speed and with precision. Additionally a multiple printing is easily possible during overprinting, without requiring the printing substrate to be returned. The separation into under-printing and overprinting occurs such that the under-printing occurs with the printing substrate being stationary and with the bridge moving in the feeding direction of the printing substrate, i.e. with the print heads moving in the feeding direction of the printing substrate, and the subsequent application of the overprinting being performed with the bridge being stationary and the printing substrate traveling.

### BRIEF DESCRIPTION OF THE DRAWINGS

The invention is explained in greater detail using an exemplary embodiment. Shown schematically are:

FIG. 1 a schematically illustrated work study during the overprinting/color printing,

FIG. 2 a schematic illustration of an inkjet printing machine.

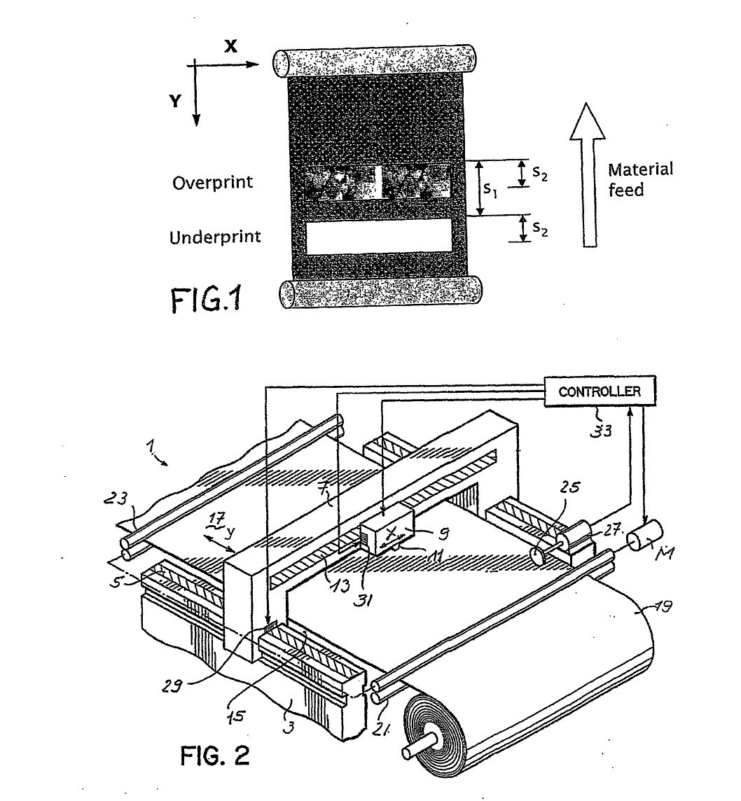

### DETAILED DESCRIPTION OF THE PREFERRED EMBODIMENTS

An inkjet printing machine, printing machine 1 for short, is marked with the reference character 1. It comprises a frame 3 having two spaced apart flanges, with a rail 5 being arranged on each of their upper edges. The two rails 5 are positioned parallel in reference to each other and carry a bridge 7, also called gantry, which can be moved on said rails 5 in the direction Y. A multi-color print head, print head 9 for short, is arranged on the bridge 7 and can be moved in the X direction. At the bottom of the print head 9, a printing nozzle 11 is shown schematically. The print head 9 is guided on a rail 13. Neither the drive for moving the bridge 7 in the Y-direction nor the drive for moving the print head 9 in the X-direction are shown in FIG. 2. They are arranged hidden inside the bridge 7.

A feeding device in the form of an endless belt can be arranged on a printing table 15, which is positioned between the two flanges having the guiding and running rails 5. For reasons of better visibility, the belt of the feeding device is not shown. Such conveyor belts are known in prior art, though. A printing substrate 17 is supported on the feeding device, e.g. a paper strip that can be pulled off a coil 19. Alternatively the printing substrate can also represent a coated textile material web, as used for example for the production of tarps for trucks. The printing substrate 17 can also be made from a transparent plastic film or from glass.

Upstream and downstream in reference to the printing table 15, the printing substrate 17 is preferably held by two pairs of clamping rollers 21 and 23. The pairs of clamping rollers 21, 23 are driven by drive motors M. They replace or support the feeding device, not shown. In order to detect the exact position of the printing substrate 17 in the Y-direction, a friction wheel 25 may be provided for example, connected to a first sensor 27 detecting the angle of rotation.

The position of the bridge 7 along the rails 5 can be exactly determined at all times by a second sensor 29. A third sensor 31 transmits the position of the print head 9 on the bridge 7 in the X-direction to a controller 33. Similar to the sensors 27, 29, 31, the motor M is also connected to the controller 33. The printing machine 1 described and shown here is known from prior art (WO2005/074519.) Of course, other similarly designed printing machines may also be used, having a print head that is arranged on a bridge, which can be moved in the feeding direction of the printing substrate.

In the following, the method for digitally printing endless printing substrates 17 on such printing machines 1 is explained in greater detail. After the placement of the printing substrate 17, e.g., a truck tarp with an intense color, e.g. a red color, onto the printing table 15 the printing substrate is precisely held temporarily on said printing table 15 by suction nozzles, which are preferably arranged therein.

The under-printing and/or white printing begins by the print head 9 being moved perpendicularly in reference to the feeding direction, i.e. in the X-direction. Between times (after printing each X-direction row), the print head 9 with the bridge 7 is moved in the feeding direction, i.e. in the Y-direction, with the printing substrate 17 being stationary. After the bridge 7 has traveled a predetermined distance s₁ in the Y-direction, the print head 9 and the bridge 7 return in the feeding direction Y to the position where the under-printing had previously begun. Here, the distance Si is equivalent to the distance between the under-printing position and the overprinting position in the Y-direction. Now, the overprinting and/or color printing begins there, on the one side by the print head 9 being moved to and fro in the X-direction in a manner known per se and on the other side with the printing substrate 17 with the feeding device, not shown, and/or the clamping rollers 21, 23 being moved in the Y-direction.

After the printing substrate 17 was moved over a predetermined distance s₂ during overprinting, the print head 9 with the bridge 7 is moved back in the Y-direction to the place of the under-printing. Here, the under-printing is continued by once more the print head 9 being moved to and fro in the X-direction with between times the bridge 7 being also moved accordingly. After the bridge 7 has been moved in the Y-direction over the same predetermined distance s₂ during under-printing, once more the bridge 7 is moved to the place of the overprinting. The alternation of under-printing and overprinting occurs until the under-printing has been completely finished. Subsequently the overprinting and/or the color printing are finally applied.

In a variant of the method, during under-printing colored printer dots are applied and during the overprinting white printer dots.

This variant begins with the under-printing and/or color printing by the print head 9 being moved in the X-direction and the printing substrate 17 being fed between times in the Y-direction until the printing substrate 17 has traveled a predetermined distance s₁. Subsequently the print head 9 and the bridge 7 move in the Y-direction to the place where previously the under-printing had begun. Here, the overprinting and/or white printing begins on the one side by the print head 9 being moved to and fro in the X-direction in a manner known per se and on the other side the bridge 7 being moved between times in the Y-direction, with the printing substrate 17 being stationary. After the bridge has traveled the predetermined distance s₂ during overprinting the bridge 7 is moved to the place of the under-printing. Here, the under-printing continues by once more the print head 9 being moved to and fro in the X-direction and the printing substrate 17 being moved between times in the Y-direction. After the printing substrate 17 has been moved over the same distance s₂ during under-printing the bridge 7 is once more moved to the place of the overprinting.

The alternation of under-printing and overprinting occurs until the under-printing is completely finished. Subsequently the overprinting and/or white printing is applied completely.

In particular cases, the under-printing can also be executed in color and the overprinting in the form of white printing.

Further, it is possible after under-printing to perform two overprintings or two under-printings and one overprinting.

The drying of the prints can occur after each layer.

1. A method for digitally printing endless printing substrates (17) on an inkjet printing machine (1) having a precise feeding device (21, 23) for the printing substrate (17) and a bridge (7) that can be moved in a feeding direction Y of the printing substrate (17) as well as a print head (9) that can be moved in an X-direction on the bridge (7) perpendicularly in reference to the feeding direction Y, with in the method an under-printing being applied onto the printing substrate (17) prior to overprinting, the method comprising:
a) alternately applying a print onto the printing substrate (17) while it is held stationary by moving the print head (9) on the bridge (7) in the X-direction and by moving the bridge (7) in the feeding direction Y,
b) moving the bridge (7) over a distance s₁ in the Y-direction, and
c) applying a print onto the printing substrate by moving the print head (9) on the bridge (7) in the X-direction and by transporting the printing substrate (17) by a feeding device (21, 23) in the Y-direction with the bridge (7) being stationary.

2. A method according to claim 1, wherein
a) applying the under-printing onto the printing substrate (17) over a first area, extending perpendicularly in reference to the printing substrate (17), by moving the print head (9) on the bridge (7) in the X-direction and onto the stationary printing substrate (17) by moving the bridge (7) in the feeding direction Y,
b) moving the bridge (7) over the distance s₁, and
c) overprinting the first area, provided with the under-printing, via nozzles of the print head by moving the print head (9) on the bridge in the X-direction and by the moving the printing substrate (17) with the feeding device (21, 23) in the Y-direction, with the bridge (7) being stationary.

3. A method according to claim 1, wherein
a) by moving the print head (9) on the bridge (7) in the X-direction and after the moving of the printing substrate (17) with the feeding device (21, 23), applying an under-printing in the Y-direction, with the bridge (7) being stationary,
b) moving the bridge (7) over a distance s₁, and
c) applying an overprinting to the stationary printing substrate (17) onto the under-printing by moving the print head (9) on the bridge (7) in the X-direction and by moving the bridge (7) in the feeding direction Y.

4. A method according to claim 2, wherein two of the under-printings occur prior to the overprinting.

5. A method according to claim 2, wherein two of the overprintings occur after the under-printing.

6. A method according to claim 4, wherein the under-printings and the overprintings are in color or white or transparent.

7. A method according to claim 2, wherein after the overprinting another overprinting occurs, during which the print head (9) is moved on the bridge (7) in the Y-direction with the printing substrate (17) being stationary.

8. A method according to claim 1, wherein each printed layer is dried.
